(19) United States
(12) Patent Application Publication
(10) Pub. No.: US 2015/0349650 A1
(43) Pub. Date: Dec. 3, 2015

(54) METHOD FOR COMMUNICATING ELECTRONIC APPARATUS WITH ADAPTOR VIA SPECIFIC COMMUNICATION INTERFACE TO ADJUST OPERATION BEHAVIOR OF ADAPTOR, ELECTRONIC APPARATUS, AND CORRESPONDING ADAPTOR

(71) Applicant: MEDIATEK INC., Hsin-Chu (TW)

(72) Inventors: Chuan-Chang Lee, Hsinchu County (TW); Chih-Yuan Hsu, Hsinchu City (TW)

(21) Appl. No.: 14/758,804

(22) PCT Filed: Apr. 21, 2014
(86) PCT No.: PCT/CN2014/075768

§ 371 Date: Jul. 1, 2015

Related U.S. Application Data
(60) Provisional application No. 61/823,006, filed on May 14, 2013.
(60) Provisional application No. 61/814,598, filed on Apr. 22, 2013.

(51) Int. Cl. H02M 3/335; H02M 1/44

(52) U.S. Cl. CPC H02M 3/33507; H02M 1/44

(57) ABSTRACT

A method for communicating an electronic apparatus with an adaptor via a specific communication interface includes: communicating the electronic apparatus with the adaptor by using the electronic apparatus to generate a specific information pattern on a signal port of the specific communication interface; and in response to the specific information pattern received on the signal port, the adaptor adjusting at least one operation behavior.

### CROSS REFERENCE TO RELATED APPLICATIONS

The application claims the benefit of U.S. Provisional Application No. 61/814,895, which was filed on Apr. 22, 2013, and the benefit of U.S. Provisional Application No. 61/823,006, which was filed on May 14, 2013.

### BACKGROUND

Generally speaking, it is fast enough to use an adaptor to charge for a well-known feature phone device by merely using a current of 600 mA. However, it is not fast enough to use the adaptor to charge a smartphone device by merely using the same current of 600 mA. Usually, a conventional charging scheme adopts a current of at least 1 A or even 3 A to charge the smartphone device for reducing total charging time. Unfortunately, even though the smartphone device is charged by using a large current such as 1 A or 3 A, it is possible that the total charging time cannot be effectively reduced. This is because the voltage level supplied by the adaptor may be reduced from a nominal level to a lower level significantly due to cable losses if the adaptor is connected to the smartphone device via a cable line. Once the supplied voltage level becomes lower for the smartphone device, it is necessary to consume a longer charging time for charging the smartphone device. Accordingly, the charging efficiency of the conventional charging scheme is not improved effectively.

### SUMMARY

It is therefore one of the objectives of the present invention to provide an electronic apparatus, a computer readable medium storing instructions, and a method for communicating the electronic apparatus with an adaptor via a specific communication interface. With the communication ability, the electronic device is able to send requests to the adaptor to, for example, control the adaptor for adjusting the voltage level supplied by the adaptor, to solve the above-mentioned problem.

According to an embodiment of the present invention, a method for communicating an electronic apparatus with an adaptor via a specific communication interface is disclosed. The method comprises: in the electronic apparatus, determining whether to adjust a voltage level supplied by the adaptor; and when the voltage level is determined to be adjusted, communicating the electronic apparatus with the adaptor by using the electronic apparatus to generate a specific information pattern on a signal port of the specific communication interface, the specific information pattern being used for indicating voltage adjustment of the adaptor for charging the electronic apparatus.

According an embodiment of the present invention, a computer readable medium comprising a plurality of instructions configured for execution at an electronic apparatus is disclosed. The instructions are configured to cause the electronic apparatus to: in the electronic apparatus, executing at least one software element for determining whether to adjust a voltage level supplied by the adaptor; and when the voltage level is determined to be adjusted, communicating the electronic apparatus with the adaptor by using the electronic apparatus to generate specific information pattern on a signal port of the specific communication interface, the specific information pattern being used for indicating voltage adjustment of the adaptor for charging the electronic apparatus.

According to an embodiment of the present invention, an electronic apparatus including a computer readable medium comprising a plurality of instructions configured for execution at the electronic apparatus is disclosed. The instructions are configured to cause the electronic apparatus to: in the electronic apparatus, executing at least one software element for determining whether to adjust a voltage level supplied by the adaptor; and when the voltage level is determined to be adjusted, communicating the electronic apparatus with the adaptor by using the electronic apparatus to generate specific information pattern on a signal port of the specific communication interface, the specific information pattern being used for indicating voltage adjustment of the adaptor for charging the electronic apparatus.

According to an embodiment of the present invention, an electronic apparatus for communicating with an adaptor via a specific communication interface is disclosed. The electronic apparatus comprises: means for determining whether to adjust a voltage level supplied by the adaptor; and means for communicating the electronic apparatus with the adaptor by using the electronic apparatus to generate a specific information pattern on a signal port of the specific communication interface when the voltage level is determined to be adjusted, the specific information pattern being used for indicating voltage adjustment of the adaptor for charging the electronic apparatus.

According to an embodiment of the present invention, an electronic apparatus for communicating with an adaptor via a specific communication interface is disclosed. The electronic apparatus comprises a processor and an encoding circuit. The processor is used for determining whether to adjust a voltage level supplied by the adaptor. The encoding circuit is coupled to the processor and used for generating a specific information pattern being used for indicating voltage adjustment of the adaptor for charging the electronic apparatus. The processor is arranged to communicate with the adaptor by controlling the encoding circuit to generate the specific information pattern on a signal port of the specific communication interface when the voltage level is determined to be adjusted.

According to an embodiment of the present invention, an adaptor for communicating with an electronic apparatus via a specific communication interface is disclosed. The adaptor comprises a receiving circuit and a decoding circuit. The receiving circuit is used for receiving a specific information pattern through a signal port of the specific communication interface where the specific information pattern is used for indicating voltage adjustment of the adaptor for charging the electronic apparatus. The decoding circuit is coupled to the receiving circuit and used for decoding the specific information pattern.

According to an embodiment of the present invention, a method for communicating an electronic apparatus with an adaptor via a specific communication interface is disclosed. The method comprises: communicating the electronic apparatus with the adaptor by using the electronic apparatus to generate a specific information pattern on a signal port of the specific communication interface; and in response to the specific information pattern received on the signal port, the adaptor adjusting at least one operation behavior.

According to the above embodiments, the electronic apparatus can communicate with the adaptor via a specific communication interface such as a USB communication interface in order to adjust a voltage level supplied by the adaptor for achieving the purpose of fast charging, over voltage protection, or others.

These and other objectives of the present invention will no doubt become obvious to those of ordinary skill in the art after reading the following detailed description of the preferred embodiment that is illustrated in the various figures and drawings.

### BRIEF DESCRIPTION OF DRAWINGS

FIG. 1 is a simplified block diagram of an electronic system according to embodiments of the present invention.

FIG. 2 is a flowchart diagram illustrating the operations of the electronic apparatus according to the embodiments of FIG. 1.

FIG. 3 is a diagram of an electronic system according a first embodiment of the present invention.

FIG. 4 is a diagram of an electronic system according a second embodiment of the present invention.

FIG. 5 is a diagram of an electronic system according a third embodiment of the present invention.

FIG. 6A is a diagram of an electronic system according a fourth embodiment of the present invention.

FIG. 6B is a diagram of the electronic system as shown in FIG. 6A by using the current sensing terminal CS to sense the current loading condition of the primary circuit.

FIG. 7 is a diagram of an electronic system according a fifth embodiment of the present invention.

FIG. 8 is a simplified block diagram illustrating an example of the ADC circuit as shown in FIG. 1.

FIG. 9 is a diagram of an electronic system according to sixth embodiment of the present invention.

### DETAILED DESCRIPTION

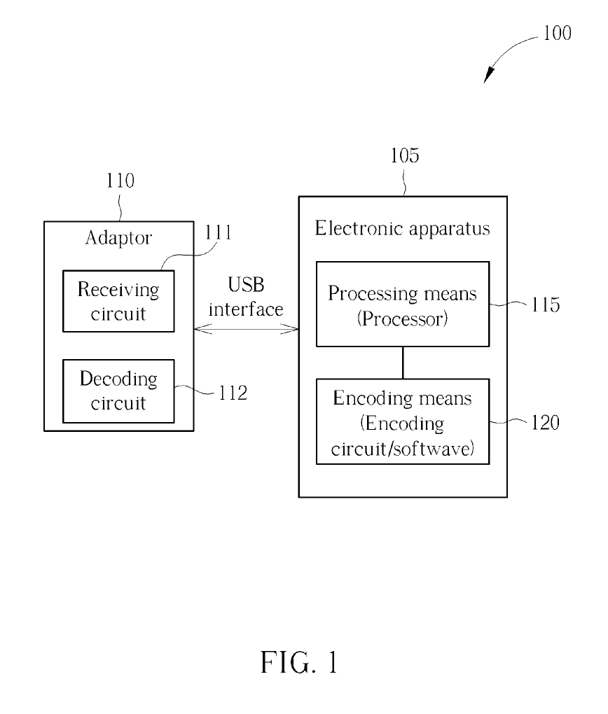

Please refer to FIG. 1, which is a simplified block diagram of an electronic system 100 according to embodiments of the present invention. The electronic system 100 comprises an electronic apparatus 105 such as a mobile phone device and an adaptor 110. The adaptor 110 is used for charging the electronic apparatus 105. For example, the electronic apparatus 105 may be a smart phone including a USB communication interface, and the adaptor 110 may be a USB adaptor; however, this is not meant to be a limitation of the present invention. The adaptor 110 comprises a receiving circuit 111 and a decoding circuit 112. The electronic apparatus 105 comprises a block of processing means 115 such as a processor and/or processing software and a block of encoding means 120 such as an encoding circuit and/or encoding software. That is, the processing means 115 and encoding means 120 can be respectively implemented by hardware elements, software elements, and/or combinations of hardware and software elements. The electronic apparatus 105 can control the adaptor 110 to perform fast charging function for the electronic apparatus 105. The electronic apparatus 105 can communicate with the adaptor 110 via a specific communication interface such as a USB communication interface in order to send requests. The patterns or formats of the requests are pre-defined in both the electronic apparatus 105 and the adaptor 110. For example, the electronic apparatus 105 may ask the adaptor 110 to adjust a voltage level supplied by the adaptor 110 by generating a specific pattern or waveform on the USB communication interface for the adaptor 110 to receive. After the adaptor 110 decodes and recognizes the specific pattern or waveform, the adaptor 110 can accordingly adjust its output voltage. By doing this, the electronic apparatus 105 can control the adaptor 110 to perform the fast charging function for the electronic apparatus 105, to reduce charging time and improve charging efficiency. For the adaptor 110, the receiving circuit 111 is used for receiving the specific information pattern through a signal port of the specific communication interface where the specific information pattern is used for indicating voltage adjustment of the adaptor for charging the electronic apparatus 105. The decoding circuit 112 is coupled to the receiving circuit 111 and used for decoding the specific information pattern. Please note that the electronic apparatus 105 can control the adaptor 110 to raise and/or reduce the voltage level supplied by the adaptor, to achieve purposes of fast charging and/or avoiding over high voltage level. In the following description, the operations of the processing means 115 and encoding means 120 are respectively illustrated by using a processor and an encoding circuit; however, this is not meant to be a limitation of the present invention.

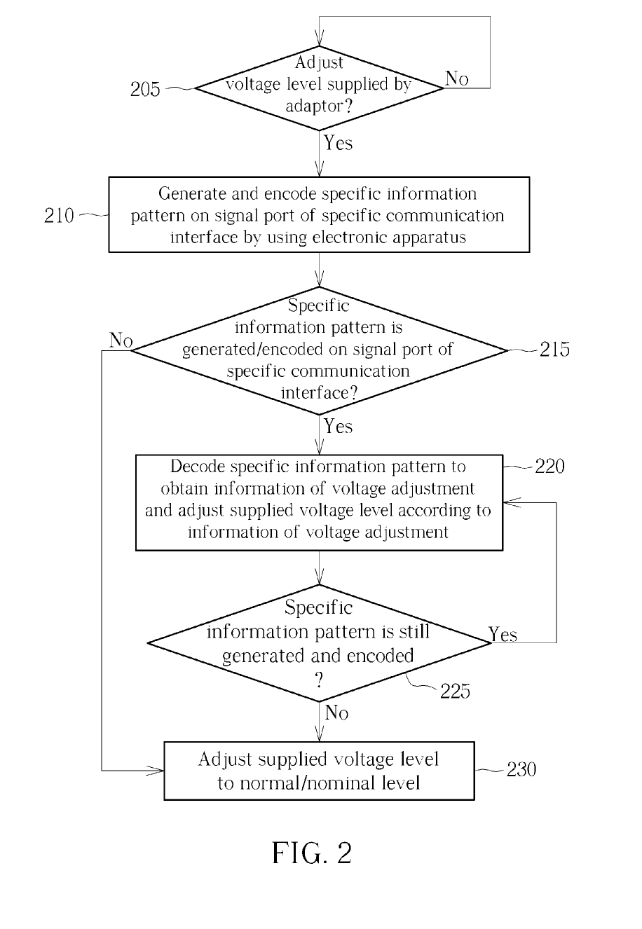

Please refer to FIG. 1 in conjunction with FIG. 2. FIG. 2 is a flowchart diagram illustrating the operations of the electronic apparatus 105 according to the embodiments of FIG. 1. Provided that substantially the same result is achieved, the steps of the flowchart shown in FIG. 2 need not be in the exact order shown and need not be contiguous, that is, other steps can be intermediate. The steps of FIG. 2 are detailed in the following.

In Step 205, the processor 115 is arranged to determine whether to adjust the voltage level supplied by the adaptor 110. Specifically, the processor 115 detects a voltage level corresponding to the supplied voltage level of the adaptor 110 and determines to raise or reduce the supplied voltage level when the voltage level has been detected is over low or over high. In addition, the processor 115 determines to adjust the voltage level when needing to raise and/or reduce the voltage level. For example, the processor 115 may determine to reduce the voltage level supplied by the adaptor 110 when needing to perform over voltage protection for a battery included within the electronic apparatus 105. On the other hand, the processor 115 may determine to adjust the voltage level supplied by the adaptor 110 to a nominal/normal level if the voltage level has been boosted and the electronic apparatus 105 is removed from the adaptor 110. That is, under different conditions, the processor 105 may determine to raise, reduce, or keep the voltage level supplied by the adaptor 110, so as to achieve the purposes of fast charging, over voltage protection, and/or other functions. In practice, the processor 115 is arranged to detect the voltage level received on one of the USB ports (e.g. the VBUS port) by the electronic-apparatus-side, and compare the detected voltage level with a reference level to generate a comparison result, wherein the detected voltage level at the electronic-apparatus-side corresponds to the output voltage level supplied by the adaptor 110 subtracted by the loss resulting from the USB cable line, and the comparison result indicates that whether the voltage level is determined to be adjusted or not.

When the voltage level is determined to be adjusted, the flow proceeds to Step 210. In Step 210, the processor 115 is arranged to control the encoding circuit 120 to generate and encode specific information pattern on a signal port of the specific communication interface (i.e. USB communication interface) so that the electronic apparatus 105 can communicate with the adaptor 110 by sending the specific information pattern to the adaptor 110 via the specific communication interface. This specific information pattern is used for indicating voltage adjustment which may be used to achieve fast charging and/or battery protection, etc. Additionally, when the voltage level is not determined to be adjusted, the flow stays in Step 205.

In Step 215, the adaptor 110 is arranged to monitor and check whether the specific information pattern is generated/encoded on the signal port of the specific communication interface. If the specific information pattern is detected, the flow proceeds to Step 220; otherwise, the flow proceeds to Step 230. In Step 220, the adaptor 110 is arranged to decode the specific information pattern to obtain information of voltage adjustment, and to raise or reduce the voltage level supplied by itself according to the information of voltage adjustment indicated by the specific information pattern outputted by the electronic apparatus 105. After adjusting the voltage level, in Step 225, the adaptor 110 is arranged to check whether specific information pattern is still generated and encoded from the electronic apparatus 105 or not. The adaptor 110 can check whether there specific information pattern exists on a signal port of the specific communication interface or not. If it is detected that the specific information pattern exists on the signal port of the specific communication interface, this indicates that the operation for adjusting the voltage level is being still performed, and the flow goes back to Step 220; otherwise, the flow proceeds to Step 230. In Step 230, the adaptor 110 is arranged to adjust the voltage level to the normal/nominal level.

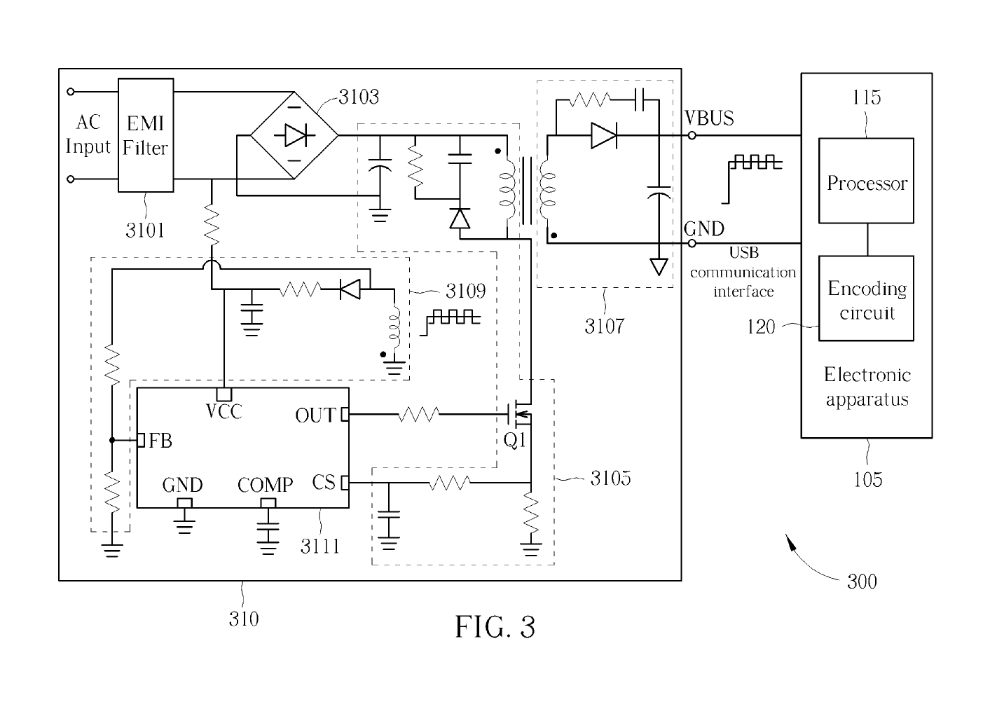

The electronic apparatus 105 can be applied into a variety of adaptors such as an adaptor including a primary-side regulator. Please refer to FIG. 3, which is a diagram of an electronic system 300 according a first embodiment of the present invention. The adaptor 310 comprises an EMI filter 3101, a rectifier 3103, a primary-side circuit 3105 including a primary coil, a secondary-side circuit 3107 including a secondary coil, an auxiliary-side circuit 3109 including an auxiliary coil, and an AC-DC circuit 3111. In this embodiment, the electronic apparatus 105 communicates with the adaptor 310 via the USB communication interface such as the USB wireless interface or the interface of USB cable, and the adaptor 310 converts the AC input to generate and supplies the voltage level for the electronic apparatus 105 via the signal port of supply line (i.e. VBUS) within the USB communication interface. The electronic apparatus 105 is connected to the adaptor 310 via the USB communication interface. For the electronic apparatus 105, when determining to adjust the voltage level supplied by the adaptor 310, the processor 115 and encoding circuit 120 are arranged to generate/encode the specific information pattern such as a specific carrier waveform on the signal port VBUS of the USB communication interface by performing means of voltage boosting. Specifically, the processor 115 can control the encoding circuit 120 to generate/encode the carrier waveform. In this embodiment, the encoding circuit 120 is utilized for generating/encoding the carrier waveform on the signal port of supply line VBUS. In practice, the encoding circuit 120 may be implemented by using a switching charger and/or a buck-boost charger. The switching charger and/or buck-boost charger is capable of exerting a voltage pulse on the signal port of supply line VBUS in a short period and not exerting the voltage pulse on the signal port of supply line VBUS in other periods. Thus, by exerting a voltage pulse (i.e. boosting or raising the voltage level to generate the voltage pulse on the signal port), the switching charger and/or buck-boost charger is able to generate the carrier waveform such as a short square waveform having 50% duty. It should be noted that the encoding circuit 120 may be implemented by using other types of circuits in other embodiments; the above implementations are merely used for illustrative purposes and should not meant to be a limitation of the present invention.

When the carrier waveform has been generated on the signal port of supply line VBUS, the carrier waveform that has been received by the secondary-side circuit 3107 is reflected to the auxiliary-side circuit 3109 when the transistor Q1 is off, and the AC-DC circuit 3111 can detect and decode the carrier waveform to obtain the information of voltage adjustment through the auxiliary-side circuit 3109. In this embodiment, the secondary-side circuit 3107 is regarded as a receiving circuit of adaptor 310 similar to the receiving circuit 111 of FIG. 1, and the AC-DC circuit 3111 is regarded as a decoding circuit of adaptor 310 similar to the decoding circuit 112 of FIG. 1. Based on the information of voltage adjustment, the AC-DC circuit 3111 can be aware of whether to raise, reduce, or keep the voltage level supplied by the adaptor 310. For example, the voltage level initially supplied by the adaptor 310 may be reduced due to cable losses of the USB cable, and this results in that it is not high enough for fast charging the electronic apparatus 105. In this situation, the electronic apparatus 105 can notify the adaptor 310 to raise its output voltage level. The electronic apparatus 105 informs the adaptor 310 of the information of voltage adjustment by encoding and sending this information via the signal port of supply line VBUS, and accordingly the AC-DC circuit 3111 can decode and be aware of the information. The adaptor 310 then raises this voltage level after detecting and decoding the information of voltage adjustment. Additionally, for instance, it may be needed to reduce the voltage level, that has been raised up, to a nominal level or to reduce an over high voltage level to a normal level. In this situation, the electronic apparatus 105 may notify the adaptor 310 to reduce its output voltage level by encoding and sending this information via the signal port of supply line VBUS, and accordingly the AC-DC circuit 3111 can decode and be aware of this inform. The adaptor 310 then reduces this voltage level after detecting and decoding the information of voltage adjustment.

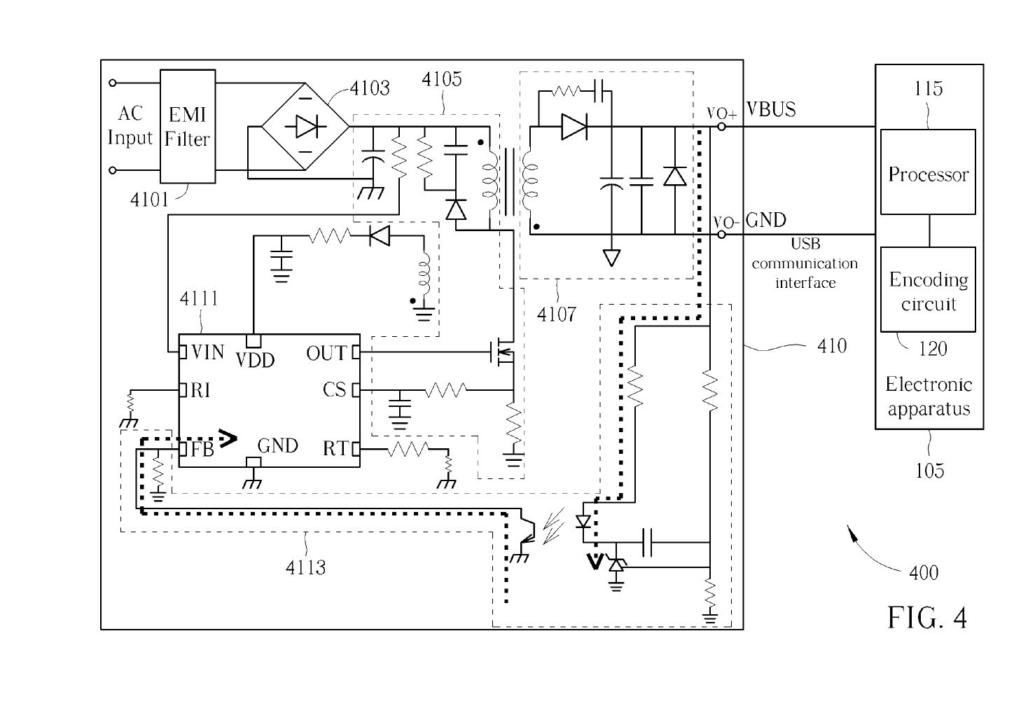

FIG. 3 depicts the adaptor 310 including a primary-side regulator. In another embodiment, the electronic apparatus 105 may be applied into another type of adaptor including a regulator such as a secondary-side regulator. Please refer to FIG. 4, which is a diagram of an electronic system 400 according a second embodiment of the present invention. The adaptor 410 comprises an EMI filter 4101, a rectifier 4103, a primary-side circuit 4105, a secondary-side circuit 4107, an AC-DC circuit 4111, and a feedback circuit 4113. The operations and functions of circuit elements included within the adaptor 410 are similar to those elements having the same names included within the adaptor 310; further description is not detailed. In this embodiment, the electronic apparatus 105 communicates with the adaptor 410 via the USB communication interface such as the USB cable, and the adaptor 410 converts the AC input to generate and supplies the voltage level for the electronic apparatus 105 via the signal port of supply line (i.e. VBUS). For the electronic apparatus 105, when determining to adjust the voltage level supplied by the adaptor 410, the processor 115 is arranged to encode and generate the specific information pattern such as a carrier waveform on the signal port VBUS of the USB interface by performing means of voltage boosting. Specifically, the processor 115 can control the encoding circuit 120 to generate and encode the carrier waveform. In this embodiment, the encoding circuit 120 is utilized for generating/encoding the carrier waveform on the signal port of supply line VBUS. In practice, the encoding circuit 120 may be implemented by using a switching charger and/or a buck-boost charger. The switching charger and/or buck-boost charger is capable of exerting a voltage pulse on the signal port of supply line VBUS in a short period and not exerting the voltage pulse on the signal port of supply line VBUS in other periods. Thus, by exerting a voltage pulse (i.e. boosting or raising the voltage level to generate the voltage pulse on the signal port), the switching charger and/or buck-boost charger is able to generate the carrier waveform such as a short square waveform having 50% duty. It should be noted that the encoding circuit 120 may be implemented by using other types of circuits in other embodiments; the above implementations are merely used for illustrative purposes and should not meant to be a limitation of the present invention.

When the carrier waveform has been generated on the signal port of supply line VBUS, the carrier waveform that has been received by the secondary-side circuit 4107 would be transmitted/reflected to the AC-DC circuit 4111 via the feedback circuit 4113 (as shown by dotted arrows of FIG. 4) where the feedback circuit 4113 is coupled between the secondary-side circuit 4107 and the AC-DC circuit 4111. The AC-DC circuit 4111 can detect and decode the carrier waveform to obtain the information of voltage adjustment through the feedback circuit 4113. In this embodiment, the secondary-side circuit 4107 is regarded as a receiving circuit of adaptor 410, and the AC-DC circuit 4111 is regarded as a decoding circuit of adaptor 410. Based on the information of voltage adjustment, the AC-DC circuit 4111 can be aware of whether to raise, reduce, or keep the voltage level supplied by the adaptor 410. For example, the voltage level initially supplied by the adaptor 410 may be wasted and reduced due to cable losses of the cable line, and this results in that it is not high enough for fast charging the electronic apparatus 105. In this situation, the electronic apparatus 105 can determine to raise the voltage level supplied by the adaptor 410. The electronic apparatus 105 informs the adaptor 410 of the information of voltage adjustment by encoding and sending this information via the signal port of supply line VBUS, and accordingly by the feedback circuit 4113 the AC-DC circuit 4111 can decode and be aware of this information. The adaptor 410 then raises this voltage level after detecting and decoding the information of voltage adjustment. Additionally, for instance, it may be needed to reduce the voltage level, that has been raised up, to a nominal level or to reduce an over high voltage level to a normal level. In this situation, the electronic apparatus 105 may determine to reduce the voltage level supplied by the adaptor 410 and inform the adaptor 410 of the information of voltage adjustment by encoding and sending this information via the signal port of supply line VBUS, and accordingly by the feedback circuit 4113 the AC-DC circuit 4111 can decode and be aware of this information. The adaptor 410 then reduces this voltage level after detecting and decoding the information of voltage adjustment.

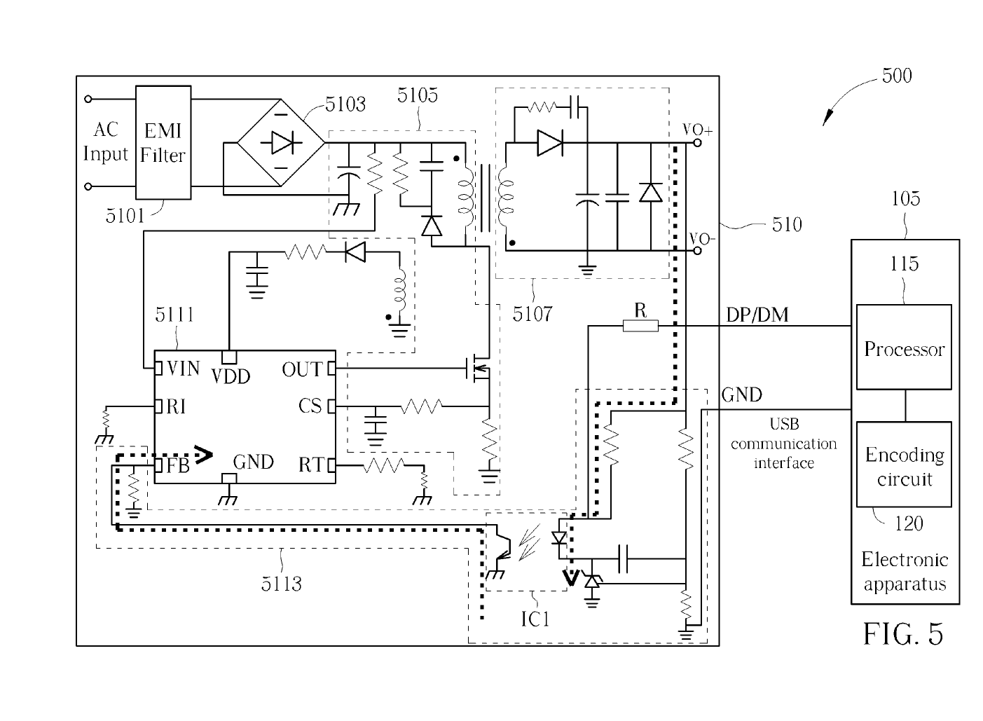

Additionally, the electronic apparatus 105 can be arranged to communicate with an adaptor via a signal port of data line such as DP or DM defined in the USB communication interface, to encode and send the information of voltage adjustment to the adaptor. Please refer to FIG. 5, which is a diagram of an electronic system 500 according a third embodiment of the present invention. The electronic apparatus 105 communicates with the adaptor 510 via the signal port of data line DP/DM which is defined in the USB communication interface. The adaptor 510 comprises an EMI filter 5101, a rectifier 5103, a primary-side circuit 5105 including a primary coil, a secondary-side circuit 5107 including a secondary coil, an AC-DC circuit 5111, and a feedback circuit 5113. The adaptor 510 is implemented by using the topology of secondary side regulator (SSR); however, this is not meant to be a limitation of the invention.

The adaptor 510 converts the AC input to generate and supplies the voltage level for the electronic apparatus 105 via the signal port of supply line (i.e. VBUS). The electronic apparatus 105 is arranged to communicate with the adaptor 510 via the signal port of data line DP/DM defined in the USB communication interface such as a USB cable. For the electronic apparatus 105, when determining to adjust the voltage level supplied by the adaptor 510, the processor 115 and encoding circuit 120 are arranged to generate and encode a specific information pattern such as a specific carrier waveform on the signal port DP/DM by performing means of voltage boosting for the level at the signal port DP/DM. Specifically, the processor 115 can use the means of voltage boosting to form the carrier waveform on the level at the signal port DP/DM; in practice, the encoding circuit 120 may be implemented by using a switching charger and/or a buck-boost charger. The switching charger and/or buck-boost charger is capable of exerting a voltage pulse on the signal port of data line DP/DM in a short period and not exerting the voltage pulse in other periods. Thus, by exerting a voltage pulse (i.e. boosting or raising the voltage level to generate the voltage pulse on the signal port), the switching charger and/or buck-boost charger is able to generate the carrier waveform such as a short square waveform having 50% duty. It should be noted that the encoding circuit 120 may be implemented by using other types of circuits in other embodiments; the above implementations are merely used for illustrative purposes and should not meant to be a limitation of the present invention.

When the carrier waveform has been generated on the signal port of data line DP/DM, the carrier waveform correspondingly causes and generates a current change which would be summed with the current from the secondary circuit 5107, and then a summation current is provided to the feedback circuit 5113. The feedback circuit 5113 is arranged to reflect or couple the summation current partially caused by the carrier waveform from the secondary circuit 5107 to the AC-DC circuit 5111 by using the element IC1. The feedback circuit 5113 is coupled between the secondary-side circuit 5107 and the AC-to-DC circuit 5111. The AC-DC circuit 5111 can detect and decode the carrier waveform to obtain the information of voltage adjustment through the feedback circuit 5113. In this embodiment, the feedback circuit 5113 can be regarded as a receiving circuit of adaptor 510, and the AC-DC circuit 5111 is regarded as a decoding circuit of adaptor 510. Based on the information of voltage adjustment, the ADC circuit 5111 can be aware of whether to raise, reduce, or keep the voltage level supplied by the adaptor 510. For example, the voltage level initially supplied by the adaptor 510 may be wasted and reduced due to cable losses of the cable line, and this results in that it is not high enough for fast charging the electronic apparatus 105. In this situation, the electronic apparatus 105 can determine to raise the voltage level supplied by the adaptor 510 when detecting that the voltage level is not high enough. The electronic apparatus 105 informs the adaptor 510 of the information of voltage adjustment by encoding and sending this information via the signal port of data line DP/DM, and accordingly by the feedback circuit 5113 the AC-DC circuit 5111 can decode and be aware of this information. The adaptor 510 then raises this voltage level after detecting and decoding the information of voltage adjustment. Additionally, for instance, it may be needed to reduce the voltage level, that has been raised up, to a nominal level or to reduce an over high voltage level to a normal level. In this situation, the electronic apparatus 105 may determine to reduce the voltage level supplied by the adaptor 510 and inform the adaptor 510 of the information of voltage adjustment by encoding and sending this information via the signal port of data line DP/DM, and accordingly by the feedback circuit 5113 the AC-DC circuit 5111 can decode and be aware of this information. The adaptor 510 then reduces this voltage level after detecting and decoding the information of voltage adjustment.

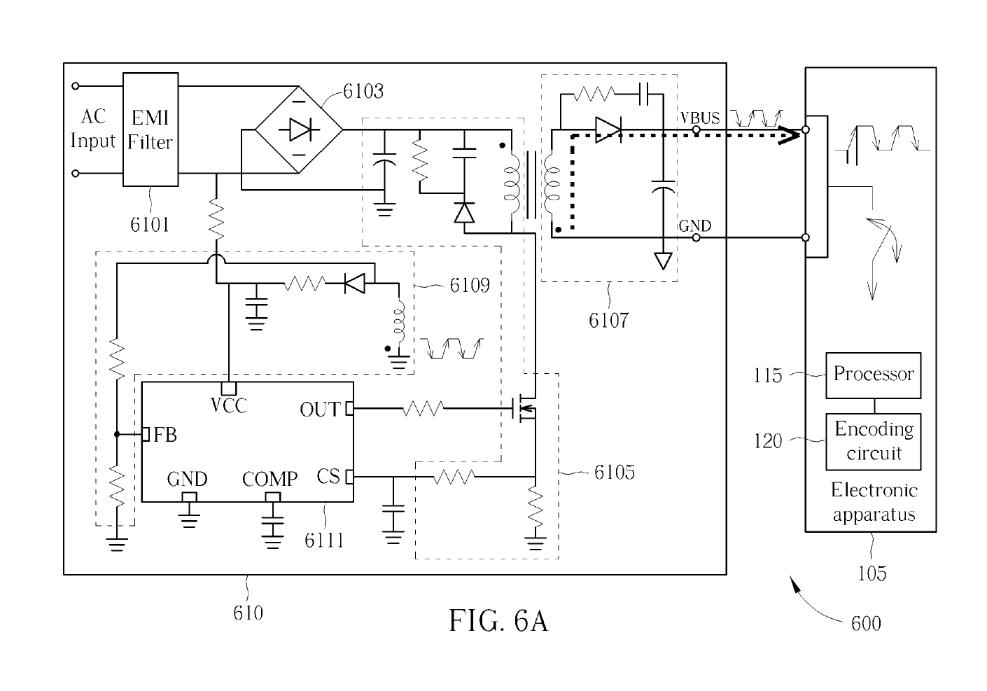

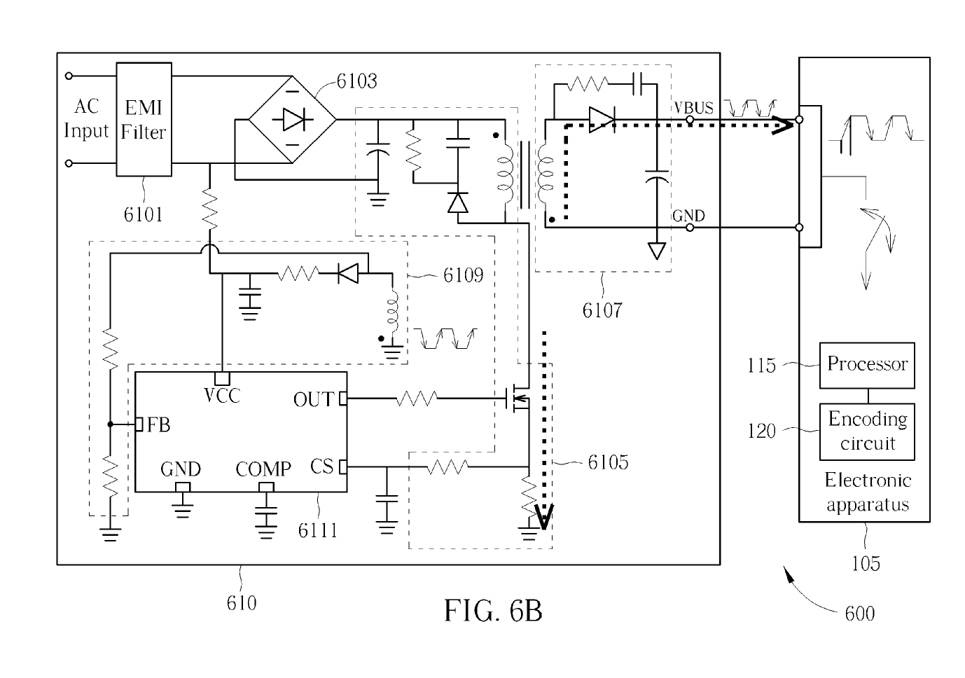

Additionally, in other embodiments, the electronic apparatus 105 may be arranged to generate, encode, and send the specific information pattern on the signal port of supply line VBUS by introducing a rapid current change into the signal port of supply line VBUS. Please refer to FIG. 6A, which is a diagram of an electronic system 600 according a fourth embodiment of the present invention. The adaptor 610 of electronic system 600 can be implemented by the topology of primary side regulator or the topology of secondary side regulator. In FIG. 6A, the adaptor 610 is implemented by using the topology of primary side regulator; however, this is no meant to be a limitation of the invention. The adaptor 610 includes an EMI filter 6101, a rectifier 6103, a primary-side circuit 6105, a secondary-side circuit 6107, an auxiliary-side circuit 6109, and an AC-DC circuit 6111. The operations and functions of circuit elements included within the adaptor 610 are similar to those elements having the same names included within the adaptor 310; further description is not detailed. When the electronic apparatus 105 determines to adjust (raise or reduce) the voltage level supplied by the adaptor 610, the processor 115 and encoding circuit 120 are arranged to generate and encode the information pattern on the signal port VBUS of the USB interface by intermittently extracting currents to cause voltage drops on the voltage level supplied by the adaptor 610. Specifically, the processor 115 can control the encoding circuit 120 to generate a fast/slow transient current loading on the voltage level provided by the adaptor 610, for intermittently extracting currents from the voltage level at the signal port of supply line VBUS in a specific time period. The fast/slow transient current loading causes at least a portion of power consumption, and the voltage level on the signal port of supply line VBUS will be varied correspondingly due to the fast/slow transient current loading. The transient current loading variation is pre-defined in both the electronic apparatus 105 and the adaptor 610, and the duty cycle can be non-fixed. By doing this, the encoding circuit 120 can be able to encode and/or generate the specific information pattern on the voltage level at the signal port of supply line VBUS.

In practice, the encoding circuit 120 can be implemented by using a discharging circuit used for providing a current sinking path to the adaptor 610 so as to discharge/extract currents from the adaptor 610. The fast/slow transient current loading is designed to intermittently extract currents from the adaptor 610. The encoding circuit 210 (implemented by the discharging circuit) can be arranged to generate different fast/slow transient current loadings for notifying the adaptor 610 to raise or reduce the voltage level supplied by the adaptor 610, respectively. For example, to notify the adaptor 610 of raising the voltage level, the encoding circuit 210 can generate a transient current loading which intermittently extract currents from the adaptor 610 during three longer discontinuous time intervals and two shorter discontinuous time intervals respectively. In addition, to notify the adaptor 610 of reducing the voltage level, the encoding circuit 210 can generate another transient current loading which intermittently extract currents during two longer discontinuous time intervals and three shorter discontinuous time intervals respectively. It should be noted that the above examples are merely used for illustrative purposes and not intended to be limitations of the invention. Other types of transient current loadings can be suitable. In addition, the encoding circuit 120 may be implemented by using other types of circuits in other embodiments; the above implementations are merely used for illustrative purposes and not meant to be limitations of the present invention.

When the specific information pattern has been generated on the signal port of supply line VBUS, the specific information pattern that has been received by the secondary-side circuit 6107 would be reflected to the auxiliary-side circuit 6109, and the AC-DC circuit 6111 can detect and decode the specific information pattern to obtain the information of voltage adjustment through the auxiliary-side circuit 6109. In this embodiment, the secondary-side circuit 6107 can be regarded as a receiving circuit of adaptor 610, and the AC-DC circuit 6111 is regarded as a decoding circuit of adaptor 610. Based on the information of voltage adjustment, the AC-DC circuit 6111 can be aware of whether to raise, reduce, or keep the voltage level supplied by the adaptor 610. For example, the voltage level initially supplied by the adaptor 610 may be wasted and reduced due to cable losses of the USB cable, and this results in that it is not high enough for fast charging the electronic apparatus 105. In this situation, the electronic apparatus 105 can determine to raise the voltage level supplied by the adaptor 610 when detecting that the voltage level is not high enough. The electronic apparatus 105 informs the adaptor 610 of the information of voltage adjustment by encoding and sending this information via the signal port of supply line VBUS through intermittently extracting currents from the adaptor 610, and accordingly the AC-DC circuit 6111 can decode and be aware of this information. The adaptor 610 then raises this voltage level after detecting and decoding the information of voltage adjustment. Additionally, for instance, it may be needed to reduce the voltage level, that has been raised up, to a nominal level or to reduce an over high voltage level to a normal level. In this situation, the electronic apparatus 105 may determine to reduce the voltage level supplied by the adaptor 610 and inform the adaptor 610 of the information of voltage adjustment by encoding and sending this information via the signal port of supply line VBUS through intermittently extracting currents from the adaptor 610, and accordingly the ADC circuit 6111 can decode and be aware of this information. The adaptor 610 then reduces this voltage level after detecting and decoding the information of voltage adjustment.

Further, in another embodiment, the AC-DC circuit 6111 can be aware of whether to raise, reduce, or keep the voltage level supplied by the adaptor 610 by using the current sensing terminal CS to sense the current loading condition of the primary circuit 6105. Please refer to FIG. 6B, which is a diagram of the electronic system 600 as shown in FIG. 6A by using the current sensing terminal CS to sense the current loading condition of the primary circuit 6105. As shown by the dotted arrow in FIG. 6B, when the electronic apparatus 105 generates the fast/slow transient current loading for the voltage level supplied via the signal port of supply line VBUS to intermittently extract currents, a current loading change is correspondingly introduced into the primary circuit 6105 of the adaptor 610. By using the current sensing terminal CS, the AC-DC circuit 6111 can sense and detect change of the current loading. Consequently, the AC-DC circuit 6111 can determine which action of raising, reducing, or keeping the voltage level is made by the electronic apparatus 105, and then adjusts or keeps the voltage level based on a result determined by the AC-DC circuit 6111 itself. That is, when the electronic apparatus 105 generates the fast/slow transient current loading to encode the specific information pattern on the signal port of supply line VBUS, the adaptor 610 can decode the specific information pattern to be aware of whether to adjust or keep the voltage level by sensing voltage change at the auxiliary-side circuit 6109 and/or by sensing the current change at the primary side circuit 6105. In this embodiment, the secondary-side circuit 6107 is regarded as a receiving circuit of adaptor 610, and the AC-DC circuit 6111 is regarded as a decoding circuit of adaptor 610.

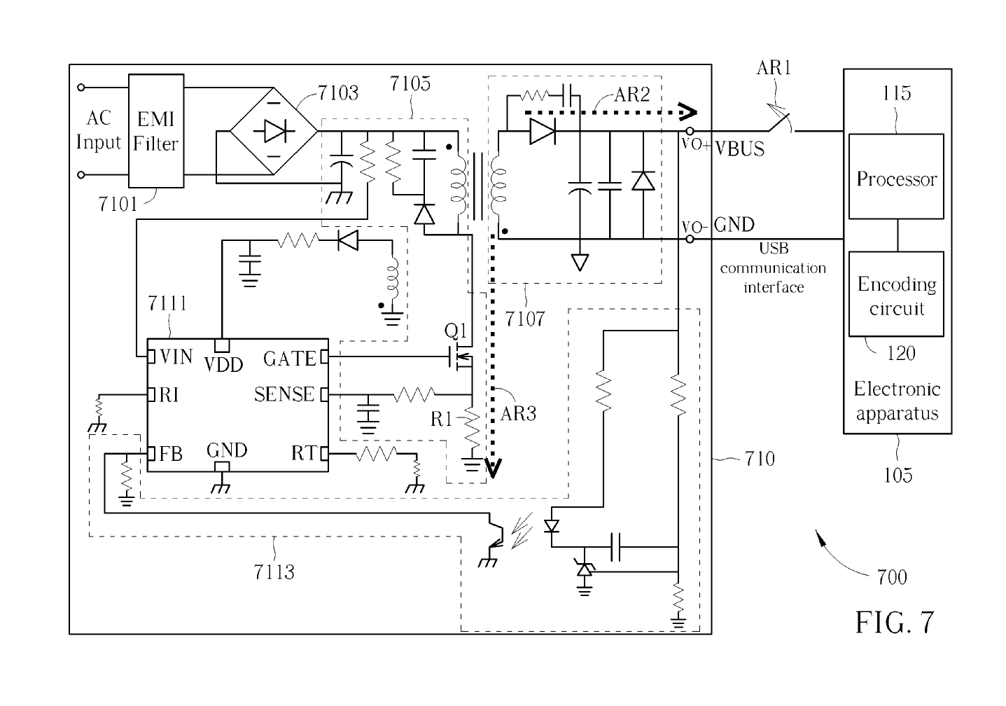

Further, in other embodiments, an adaptor is able to detect whether the electronic apparatus 105 has been removed from the adaptor and to adjust the voltage level supplied by the adaptor itself to a normal level or a nominal level after the voltage level has been raised/reduced and the electronic apparatus 105 has been removed from the adaptor. Please refer to FIG. 7, which is a diagram of an electronic system 700 according a fifth embodiment of the present invention. The adaptor 710 includes an EMI filter 7101, a rectifier 7103, a primary-side circuit 7105, a secondary-side circuit 7107, an AC-DC circuit 7111, and a feedback circuit 7113. The operations and functions of circuit elements included within the adaptor 710 are similar to those elements having the same names included within the adaptor 410; further description is not detailed. As shown in FIG. 7, the arrow AR1 indicates that the electronic apparatus 105 is removed from the adaptor 710. That is, the electronic apparatus 105 becomes disconnected to the adaptor 710. Once the electronic apparatus 105 has been removed, the current loading is reduced. The dotted arrow AR2 indicates that the current is reduced after the electronic apparatus 105 has been removed from the adaptor 710. The current reduction is reflected to the primary-side circuit 7105, and the dotted arrow AR3 indicates that the current passing through the primary-side circuit 7105 is reduced after the electronic apparatus 105 has been removed from the adaptor 710. Through the resistor R1, the AC-DC circuit 7111 can sense when the current reduction occurs and can be aware of whether the electronic apparatus 105 is removed from the adaptor 710 or not. In practice, the AC-DC circuit 7111 can sense the voltage difference across the resistor R1 and compare the voltage difference with a low threshold to determine whether the electronic apparatus 105 is removed from the adaptor 710 or not. In another example, the adaptor 710 can be configured to determine whether the electronic apparatus 105 has been removed or not by using a specified timer. When the specified timer has been counted for a predetermined time and no notifications with respect to information of voltage adjustment are sent to the adaptor 710, the adaptor 710 determines that the electronic apparatus 105 has been removed. After determining that the electronic apparatus 105 has been removed, the adaptor 710 is arranged to initialize the voltage level at the signal port of supply line VBUS by adjusting the voltage level back to the normal level or the nominal level for next time the adaptor 710 is used.

Please note that communications between the electronic apparatus and the adaptor may take place before the charging process. The amplitude level of the specific pattern/waveform is designed to be much smaller than the amplitude level of the charging voltage utilized for charging process. Therefore, the electronic apparatus can distinguish whether the adaptor has adjusted the output charging voltage and enters the charging process.

Further, the electronic system 100 is not limited to merely adjusting the charging behavior. In other embodiments, the electronic system 100 can adjust other different operation behaviors of the adaptor 110 by communicating the electronic apparatus 105 with the adaptor 110. That is, the electronic apparatus 105 is arranged to generate a specific information pattern on a signal port of the specific communication interface, and the adaptor 110 is arranged to adjust at least one operation behavior in response to the specific information pattern received on the signal port.

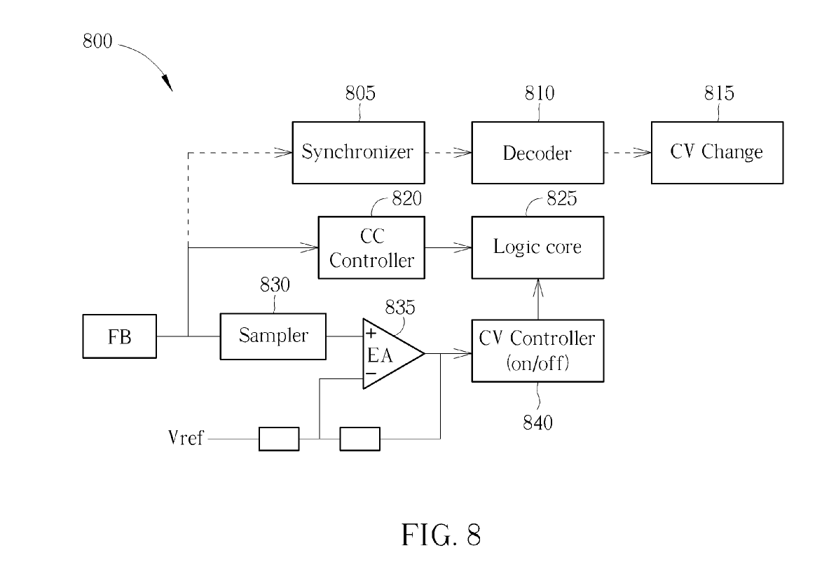

Please refer to FIG. 8, which is a simplified block diagram illustrating an example of the AC-DC circuit 800 such as the ADC circuits as shown in FIGS. 3, 4, 5, 6A-6B, and 7. As shown in FIG. 8, the AC-DC circuit 800 includes a synchronizer 805, a decoder 810, a constant voltage change block 815, a constant current controller 820, a logic core 825, a sampler 830, an amplifier 835, and a constant voltage controller 840. The synchronizer 805 is coupled to the feedback terminal FB to receive the specific information pattern such as the carrier waveform carrying or conveying information of voltage adjustment, and is configured to synchronize with the carrier waveform. In a preferred example, the operation frequency of the synchronizer 805 is twice higher that the frequency of the carrier waveform; however, this is not intended to be a limitation of the present invention. After synchronization, the decoder 810 is arranged to decode the carrier waveform to obtain the information of voltage adjustment, and the constant voltage change block 815 is arranged to adjust/change the constant voltage level supplied by the adaptor.

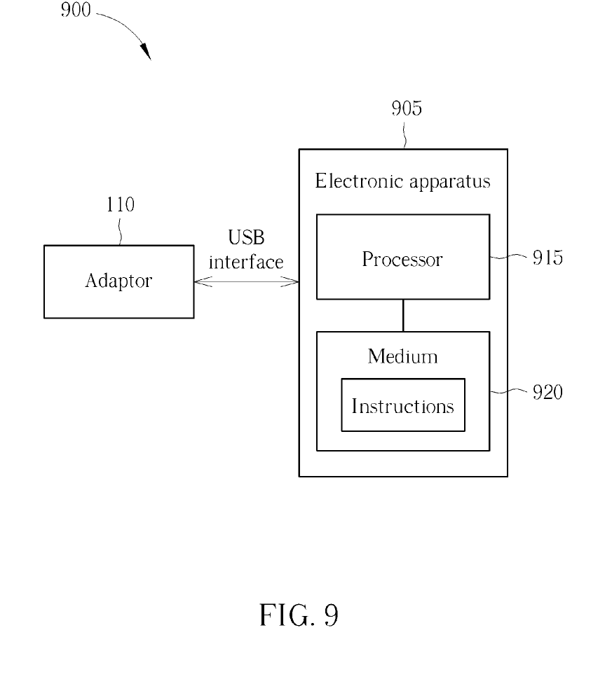

Further, the above operations and functions of the processing means 115 and encoding means 120 can be implemented by using a processor and a computer readable medium storing corresponding instructions. Please refer to FIG. 9, which is a diagram of an electronic system 900 according to sixth embodiment of the present invention. The electronic system 900 comprises a processor 915 and a computer readable medium 920. The computer readable medium 920 comprises a plurality of instructions configured for execution on the processor 915. The instructions are configured to cause the electronic apparatus 905 to: in the electronic apparatus 905, executing at least one software element for determining whether to adjust a voltage level supplied by the adaptor 110; and when the voltage level is determined to be adjusted, communicating the electronic apparatus 905 with the adaptor 1190 by using the electronic apparatus 905 to generate specific information pattern on a signal port of the specific communication interface, the specific information pattern being used for indicating voltage adjustment of the adaptor for charging the electronic apparatus.

Those skilled in the art will readily observe that numerous modifications and alterations of the device and method may be made while retaining the teachings of the invention. Accordingly, the above disclosure should be construed as limited only by the metes and bounds of the appended claims.

1. A method for communicating an electronic apparatus with an adaptor via a specific communication interface, comprising:
in the electronic apparatus, determining whether to adjust a voltage level supplied by the adaptor; and
when the voltage level is determined to be adjusted, communicating the electronic apparatus with the adaptor by using the electronic apparatus to generate a specific information pattern on a signal port of the specific communication interface, the specific information pattern being used for indicating voltage adjustment of the adaptor for charging the electronic apparatus.

2. The method of claim 1, wherein the specific communication interface is a USB communication interface, and the signal port is either a signal port of supply line or a signal port of data line.

3. The method of claim 1, wherein the step of determining whether to adjust the voltage level comprises:
using the electronic apparatus to detect a voltage level corresponding to the voltage level supplied by the adaptor;
comparing the detected voltage level with a reference level to generate a comparison result, the comparison result being used for indicating whether the voltage level supplied by the adaptor is to be adjusted.

4. The method of claim 1, wherein the step of generating the specific information pattern on the signal port of the specific interface comprises:
generating a specific waveform on the signal port of the specific interface, the specific waveform conveying information of voltage adjustment; and
wherein the information of voltage adjustment conveyed by the specific waveform is decoded by the adaptor so that the adaptor is capable of raising or reducing the voltage level supplied by the adaptor.

5. The method of claim 4, wherein the step of generating the specific waveform on the signal port comprises:
generating a carrier waveform on the signal port by performing means of voltage boosting for the voltage level supplied by the adaptor.

6. The method of claim 5, wherein the signal port corresponds to a supply line and/or a data line.

7. The method of claim 4, wherein the step of generating the specific waveform on the signal port comprises:
generating the specific waveform on the voltage level of the signal port by using the electronic apparatus to generate transient current loading for intermittently sinking currents from the adaptor.

8. The method of claim 7, wherein the specific waveform conveys information of voltage adjustment for raising and/or reducing the voltage level.

9. The method of claim 4, wherein the signal port corresponds to a supply line defined in the specific communication interface.

10. A computer readable medium comprising a plurality of instructions configured for execution at an electronic apparatus, the instructions being configured to cause the electronic apparatus to:
in the electronic apparatus, executing at least one software element for determining whether to adjust a voltage level supplied by the adaptor; and
when the voltage level is determined to be adjusted, communicating the electronic apparatus with the adaptor by using the electronic apparatus to generate specific information pattern on a signal port of the specific communication interface, the specific information pattern being used for indicating voltage adjustment of the adaptor for charging the electronic apparatus.

11. An electronic apparatus including a computer readable medium comprising a plurality of instructions configured for execution at the electronic apparatus, the instructions being configured to cause the electronic apparatus to:
in the electronic apparatus, executing at least one software element for determining whether to adjust a voltage level supplied by the adaptor; and
when the voltage level is determined to be adjusted, communicating the electronic apparatus with the adaptor by using the electronic apparatus to generate specific information pattern on a signal port of the specific communication interface, the specific information pattern being used for indicating voltage adjustment of the adaptor for charging the electronic apparatus.

12. An electronic apparatus for communicating with an adaptor via a specific communication interface, comprising:
means for determining whether to adjust a voltage level supplied by the adaptor; and
means for communicating the electronic apparatus with the adaptor by using the electronic apparatus to generate a specific information pattern on a signal port of the specific communication interface when the voltage level is determined to be adjusted, the specific information pattern being used for indicating voltage adjustment of the adaptor for charging the electronic apparatus.

13. An electronic apparatus for communicating with an adaptor via a specific communication interface, comprising:
a processor, for determining whether to adjust a voltage level supplied by the adaptor; and
an encoding circuit, coupled to the processor, for generating a specific information pattern being used for indicating voltage adjustment of the adaptor for charging the electronic apparatus, wherein the processor is arranged to communicate with the adaptor by controlling the encoding circuit to generate the specific information pattern on a signal port of the specific communication interface when the voltage level is determined to be adjusted.

14. The electronic apparatus of claim 13, wherein the specific communication interface is a USB communication interface, and the signal port is either a signal port of supply line or a signal port of data line.

15. The electronic apparatus of claim 13, wherein the processor is arranged to detect a voltage level corresponding to the voltage level supplied by the adaptor and to compare the detected voltage level with a reference level to generate a comparison result, the comparison result being used for indicating whether the voltage level supplied by the adaptor is to be adjusted.

16. The electronic apparatus of claim 13, wherein the encoding circuit is arranged to generate a specific waveform on the signal port of the specific communication interface, the specific waveform conveying information of voltage adjustment; and the information of voltage adjustment conveyed by the specific waveform is decoded by the adaptor so that the adaptor is capable of raising or reducing the voltage level supplied by the adaptor.

17. The electronic apparatus of claim 16, wherein the encoding circuit is arranged to generate a carrier waveform on the signal port by performing means of voltage boosting for the voltage level supplied by the adaptor.

18. The electronic apparatus of claim 17, wherein the signal port corresponds to a supply line and/or a data line.

19. The electronic apparatus of claim 16, wherein the encoding circuit is arranged to generate the specific waveform on the voltage level of the signal port by generating transient current loading for intermittently sinking currents from the adaptor.

20. The electronic apparatus of claim 19, wherein the specific waveform conveys information of voltage adjustment for raising and/or reducing the voltage level.

21. The electronic apparatus of claim 16, wherein the signal port corresponds to a supply line defined in the specific communication interface.

22. An adaptor for communicating with an electronic apparatus via a specific communication interface, comprising:
a receiving circuit, for receiving a specific information pattern through a signal port of the specific communication interface, the specific information pattern being used for indicating voltage adjustment of the adaptor for charging the electronic apparatus; and
a decoding circuit, coupled to the receiving circuit, for decoding the specific information pattern.

23. A method for communicating an electronic apparatus with an adaptor via a specific communication interface, comprising:
communicating the electronic apparatus with the adaptor by using the electronic apparatus to generate a specific information pattern on a signal port of the specific communication interface; and
in response to the specific information pattern received on the signal port, the adaptor adjusting at least one operation behavior.
